(19) United States
(12) Patent Application Publication
(10) Pub. No.: US 2005/0242926 A1
(43) Pub. Date: Nov. 3, 2005

(54) Method and system for contactless data transmission, and use of the method

(75) Inventor: Dominik Berger, Graz (AT)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/152,420

(22) Filed: Jun. 13, 2005

Related U.S. Application Data
(63) Continuation of application No. PCT/DE03/04029, filed on Dec. 8, 2003.

(30) Foreign Application Priority Data
Dec. 16, 2002 (DE) 102 58 779.5

(51) Int. Cl. H04Q 5/22

(52) U.S. Cl. 340/10.1; 375/268

(57) ABSTRACT

Method and system for contactless data transmission and the use of the method, the method including the step of transmitting a signal, wherein the signal in an unmodulated form is at a first signal level and in a modulated form is at a second signal level whose magnitude is greater than that of the first signal level.

### CROSS-REFERENCE TO RELATED APPLICATION

This application is a continuation of International Patent Application Serial No. PCT/DE2003/004029, filed Dec. 8, 2003, which published in German on Jul. 1, 2004 as WO 2004/055712, and is incorporated herein by reference in its entirety.

### FIELD OF THE INVENTION

The invention relates to a method and system for contactless data transmission, and to the use of the method.

### BACKGROUND OF THE INVENTION

“RFID” (Radio Frequency Identification) systems are becoming more and more widespread. They essentially comprise two components, namely a “transponder” and a detection or read/write unit. The transponder is held by an object which needs to be identified, with the detection unit making this identification contactlessly. The read unit typically contains a radio frequency module (transmitter and receiver), a control unit and a coupling element for the transponder. In addition, many read units are equipped with an additional interface, such as RS232 or the like, in order to forward the data received to another system, such as a PC or an automatic controller. The transponder, which is the actual data storage medium in an RFID system, normally comprises a coupling element and an electronic component, a “chip”.

Outside of a read unit's response range, the transponder (which normally does not have its own voltage supply) behaves entirely passively. The power required for operating the transponder is transmitted, like the clock and data, to the transponder contactlessly by the coupling unit.

As is customary in wireless data transmission, an RFID system also involves a radio frequency signal being modulated with the data which are to be transmitted. Such a method is described, by way of example, in Finkenzeller, Klaus; RFID-Handbuch [RFID Handbook], 2nd edition 2000, Karl Hansa Verlag Munich, sections 2 and 6. Ordinary ASK modulation is performed by virtue of the modulation starting such that the signal amplitude is reduced. Depending on the depth of modulation chosen, the reduction is effected. In the case of ASK 100, for example, no radio frequency signal is transmitted at the time of modulation.

Although these modulation gaps are only very short, this nevertheless means significant circuit complexity. Since the chip obtains its power from the received field, there is an absence of power for it in the modulation periods. This absence needs to be buffered accordingly.

### SUMMARY OF THE INVENTION

The invention is thus based on an object of providing a method for contactless data transmission in which the transponder in an RFID system does not require any additional complexity in order to bridge modulation gaps.

The invention includes a method and system for contactless data transmission and the use of this method, the method having a step of transmitting a signal, wherein the signal in an unmodulated form is at a first signal level and in a modulated form is at a second signal level whose magnitude is greater than that of the first signal level.

### BRIEF DESCRIPTION OF THE DRAWING

The invention is explained below with reference to the figures.

FIG. 1 shows contactless data transmission according to the present invention; and

FIG. 2 shows a transponder coupled to a read-write unit.

### DETAILED DESCRIPTION OF PREFERRED EMBODIMENTS OF THE INVENTION

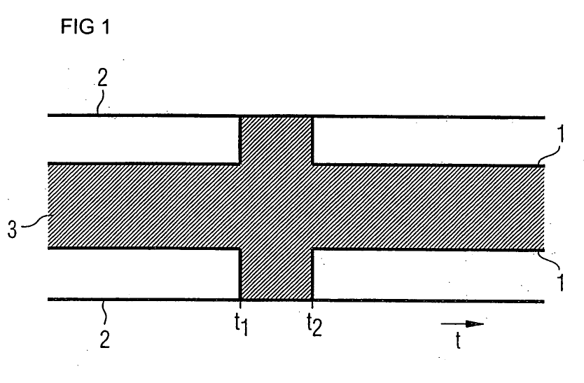

FIG. 1 shows a radio frequency signal 3, whose signal profile runs from left to right. At first, this radio frequency signal 3 oscillates between the two signal levels 1. At the time t1, modulation is performed. The signal level of the radio frequency signal adopts an increased signal level 2 from the time t1 onward and changes back to the first signal level at the time t2. At this time, the modulation has ended. The magnitude of the increased signal level may exceed that of the first signal level

It is possible to see that a transponder which receives the radio frequency signal 3 is also able to draw the power which is available to it prior to the time tl and after the time t2 from the signal 3 in the time interval between the times tl and t2. Also, a voltage supply for the transponder is designed solely for the signal in the unmodulated form.

The fact that the modulated signal produces no modulation gaps but rather an increase in level means that the transponder has the same power available at modulation times as at times in which there is no modulation.

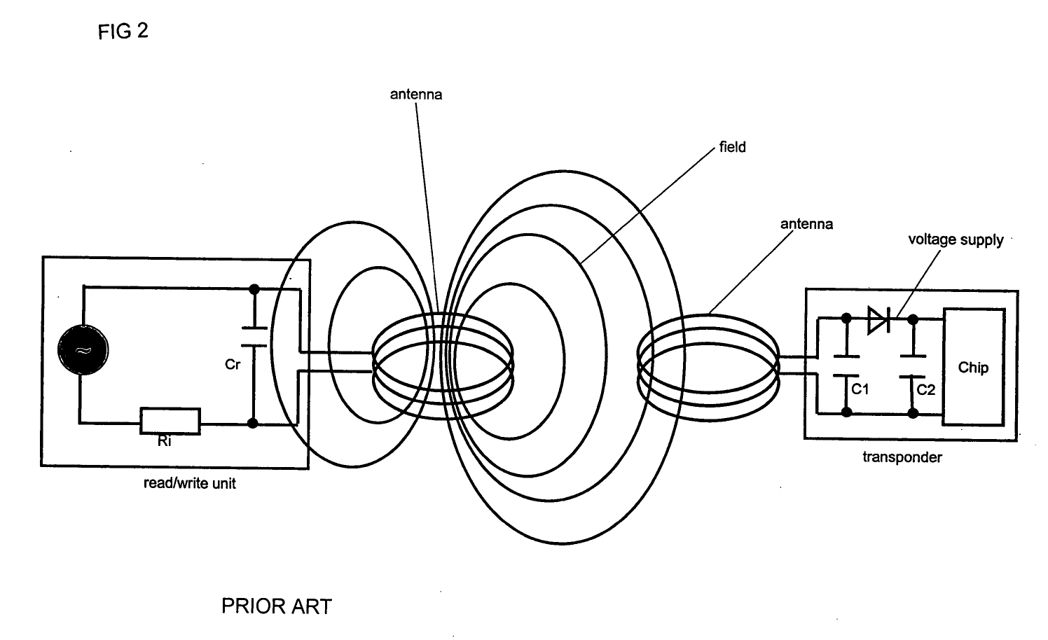

FIG. 2 shows a read/write unit and a transponder with a voltage supply connected by a magnetic field of an inductive coil. This connection well known, and thus for the sake of brevity, no further description is provided here.

1. A method for contactless data transmission, comprising the step of transmitting a signal, wherein the signal in an unmodulated form is at a first signal level and in a modulated form is at a second signal level whose magnitude is greater than that of the first signal level.

2. The method as claimed in claim 1, wherein the magnitude of the second signal level exceeds that of the first level by at least 10 percent.

3. The use of the method as claimed in patent claim 1, with a system comprising a read/write unit and a transponder which is driven by the read/write unit, wherein the signal which is output by the read/write unit is modulated in accordance with the method.

4. The use of the method as claimed in patent claim 2, with a system comprising a read/write unit and a transponder which is driven by the read/write unit, wherein the signal which is output by the read/write unit is modulated in accordance with the method.

5. The use as claimed in claim 3, wherein a voltage supply for the transponder is designed solely for the signal in the unmodulated form.

6. The use as claimed in claim 4, wherein a voltage supply for the transponder is designed solely for the signal in the unmodulated form.

7. A system for contactless data transmission, comprising:
a read/write unit that transmits a signal; and
a transponder driven by the read/write unit,
wherein the signal in an unmodulated form is at a first signal level and in a modulated form is at a second signal level whose magnitude is greater than that of the first signal level.

8. The system as claimed in claim 7, wherein the magnitude of the second signal level exceeds that of the first level by at least 10 percent.

9. The system as claimed in claim 7, further comprising a voltage supply for the transponder designed solely for the signal in the unmodulated form.

10. A system for contactless data transmission, comprising:
a read/write means for transmitting a signal; and
a transponder means driven by the read/write unit,
wherein the signal in an unmodulated form is at a first signal level and in a modulated form is at a second signal level whose magnitude is greater than that of the first signal level.

11. A computer program having a program code for performing a method for contactless data transmission, comprising the step of transmitting a signal, wherein the signal in an unmodulated form is at a first signal level and in a modulated form is at a second signal level whose magnitude is greater than that of the first signal level.

12. A system for contactless data transmission, the system comprising:
a processor;
a memory communicatively coupled to the processor; and
software executing in the processor configured to transmit a signal, wherein the signal in an unmodulated form is at a first signal level and in a modulated form is at a second signal level whose magnitude is greater than that of the first signal level.

13. A system for contactless data transmission, the system comprising:
a read/write unit that transmits a signal;
a transponder driven by the read/write unit;
a processor;
a memory communicatively coupled to the processor; and
software executing in the processor configured to transmit the signal from the read/write unit, wherein the signal in an unmodulated form is at a first signal level and in a modulated form is at a second signal level whose magnitude is greater than that of the first signal level.
